(19) United States
(12) Patent Application Publication
(10) Pub. No.: US 2014/0218167 A1
(43) Pub. Date: Aug. 7, 2014

(54) WIRELESSLY SENSED AND CONTROLLED LOCKING DEVICE

(71) Applicant: K-JUMP HEALTH CO., LTD., New Taipei City (TW)

(72) Inventor: Daniel C.M. TSENG, New Taipei City (TW)

(73) Assignee: K-JUMP HEALTH CO., LTD., New Taipei City (TW)

(21) Appl. No.: 13/758,438

(22) Filed: Feb. 4, 2013

(51) Int. Cl. E05B 47/02

(52) U.S. Cl. CPC E05B 47/02
USPC 340/5.61

(57) ABSTRACT

A wirelessly sensed and controlled locking device is identified, sensed and controlled by a mobile electronic device to be locked or unlocked. The mobile electronic device comprises a battery, an information transmission chip and a first RF antenna. The wirelessly sensed and controlled locking device comprises a second RF antenna receiving information and electromagnetic waves from the first RF antenna, an information receiving/transmitting unit controlling the second RF antenna to receive and transmit information, a power storing/supplying unit converting electromagnetic waves received by the second RF antenna into current and temporarily storing power of the current, and also temporarily storing power from the information receiving/transmitting unitit, an information comparing/processing unit powered by the power storing/supplying unit to compare and process information from the information receiving/transmitting unit, and a switch driving/controlling unit powered by the power storing/supplying unit and controlled by the information comparing/processing unit to perform locking or unlocking.

### FIELD OF THE INVENTION

The present invention relates to a locking device and particularly to a locking device which can be wirelessly identified, sensed and controlled by a mobile electronic device to be locked or unlocked using a wireless technology.

### BACKGROUND OF THE INVENTION

At present, the persistent economic depression has raised the unemployment rate and indurectly worsened the public security problem. Theft, trespass and the like occurs frequently and brings insecurity to people. Hence, people are likely to seek for more effective methods to prevent the crimes from threatening their bodies and properties.

Thus, there are manufacturers installing iron grilles, iron doors or hard-to-break locks for houses to prevent from thefts. Further, it can also be seen everywhere that various locks are applied to steering wheels, gearshift levers of automobiles and wheels of motorcycles to prevent from theft or to increase the time and risk takenby the thief.

A passive RFID (Radio Frequency Identification, RFID) lock controller structure according to a Taiwan patent NO. M388691, disclosed a passive FRID label which is installed in a key, a reader is arranged in a locking device to emits electromagnetic energy to induces current in the passive RFID label through a resonant coupling therebetween, An identification code is converted into a signal and transmitted to the reader. Wherein, a lock latch control program examines whether the identification code is valid and determines whether to lock/unlock the locking device.

In the abovementioned prior art, it is necessary to power the locking device all the time in a normal state. In other words, the locking device needs to be additionaally connected with the power source to induce the unpowered passive RFID label in a key, so that the key (RFID label) having been inserted into the locking device can be rotated to unlock the locking device. If the power supply of the locking device is interrupted (e.g. electric power blackout) and the lock latch is still in a locked state, the lock latch would not operate normally. Thus, it causes a serious problem that the locking device cannot be unlocked by the key.

### SUMMARY OF THE INVENTION

The primary objective of the present invention is to provide a wirelessly sensed and controlled locking device to overcome the abovementioned technical problem, wherein the user needn't carry any key, instead, by using a mobile electronic device to lock or unlock a locking device, whereby no key will be lost and increased the convenience of locking or unlocking a locking device. The wirelessly sensed and controlled locking device of the present invention is characterized in that it can be locked or unlocked normally without connecting with any external power source. Therefore, the user is exempted from the conventional problem that the locking device cannot be locked or unlocked during power outage. Further, the present invention has an energy-saving and environmental-protection efficacy.

To achieve the abovementioned objective, the present invention proposes a wirelessly sensed and controlled locking device, which is wirelessly identified, sensed and controlled by a mobile electronic device to be locked or unlocked. The mobile electronic device comprises a battery, an information transmitting chip powered by the battery, and a first RF (Radio Frequency) antenna transmitting information of the information transmitting chip through an electromagnetic waves. The wirelessly powered and controlled locking device comprises a second RF antenna receiving the information and the electromagnetic waves of the first RF antenna, an information receiving/transmitting unit controlling the second RF antenna to receive and transmit the information, a power storing/supplying unit converting the electromagnetic waves received by the second RF antenna into current and temporarily storing power of the current and temporarily storing power from the information receiving/transmitting unit, an information comparing/processing unit powered by the power storing/supplying unit to compare and process the information from the information receiving/transmitting unit and a switch driving/controlling unit powered by the power storing/supplying unit and controlled by the information comparing/processing unit to perform locking or unlocking operation.

### BRIEF DESCRIPTION OF THE DRAWINGS

FIG. 1 is a block diagram of a first embodiment of the present invention;

FIG. 2 is a sectional view of the first embodiment of the present invention of FIG. 1;

FIG. 3 is a sectional view of the strcture of another aspect of the first embodiment of the present invention of FIG. 1;

FIG. 4 is a schematic view showing the unlocking operation of the present invention shown in FIG. 3;

FIG. 5 is a block diagram of a second embodiment of the present invention;

FIG. 6 is a sectional view of the second embodiment of the present invention of FIG. 5;

FIG. 7 is a schematical view showing the unlocking operation of the present invention of FIG. 6; and

FIG. 8 is a schematical view showing the successive unlocking operation of present invention of FIG. 7.

### DETAILED DESCRIPTION OF THE PREFERRED EMBODIMENTS

The technical contents of the present invention are described in detail in cooperation with drawings below.

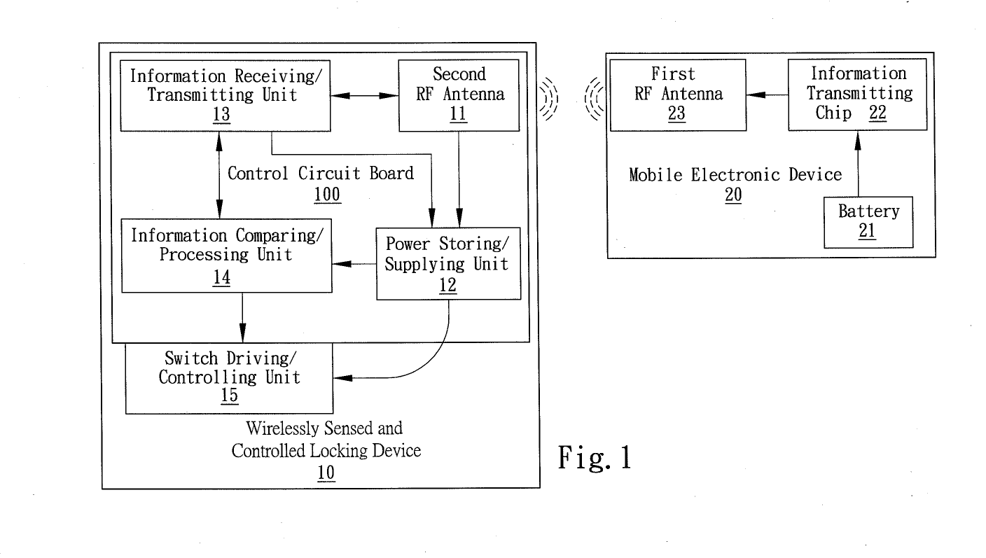

Refer to FIG. 1 for a block diagram of a first embodiment of the present invention showing a wirelessly sensed and controlled locking device 10 is wirelessly sensed and controlled by a mobile electronic device 20 to be locked or unlocked. The first embodiment may be constructed according to a NFC (Near-Field Communication) system and adopt the mainstream ISO14443A/B near-field induction technology. The mobile electronic device 20, e.g. a mobile phone, PDA, tablet PC and the like which comprises a battery 21, an information transmitting chip 22 powered by the battery 21 and including an identification code and a first RF (Radio Frequency) antenna 23 transmitting the identification code of the information transmitting chip 22 through an electromagnetic waves. The wirelessly sensed and controlled locking device 10 comprises a second RF antenna 11 receiving the identification code and the electromagnetic waves from the first RF antenna 23, an information receiving/transmitting unit 13 controlling the second RF antenna 11 to receive and transmit the identification code, a power storing/supplying unit 12 converting the electromagnetic waves received by the second RF antenna 11 into current and temporarily storing power of the current and temporarily storing power from the information receiving/transmitting unit 13, an information comparing/processing unit 14 powered by the power storing/supplying unit 12 to compare and process the identification code from the information receiving/transmitting unit 13 and a switch driving/controlling unit 15 powered by the power storing/supplying unit 12 and controlled by the information comparing/processing unit 14 to perform locking or unlocking of the locking device 10. The second RF antenna 11, the power storing/supplying unit 12, the information receiving/transmitting unit 13, the information comparing/processing unit 14 and the switch driving/controlling unit 15 are all electrically connected to and installed on a control circuit board 100.

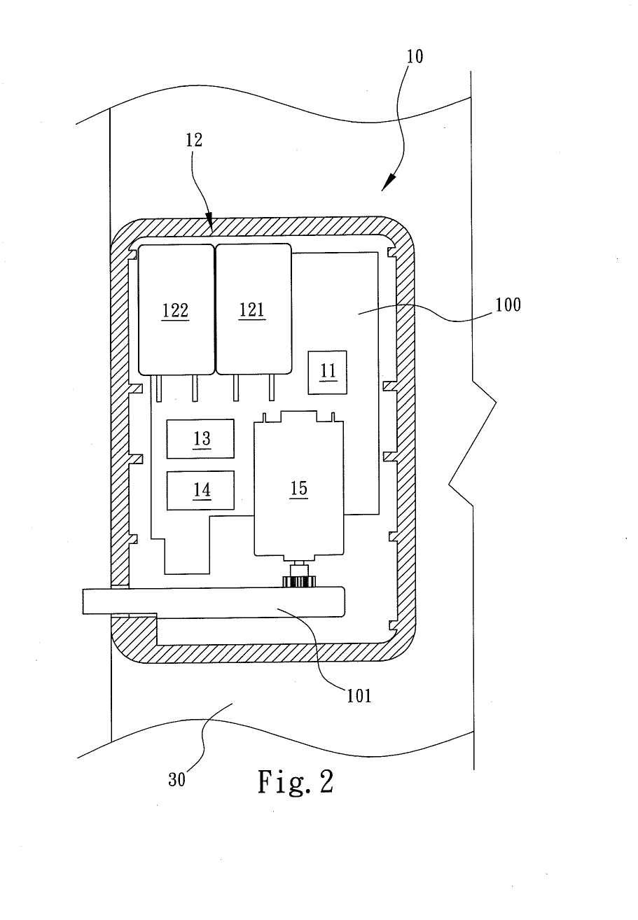

Referring to FIG. 2, the switch driving/controlling unit 15 powered by the power storing/supplying unit 12 and controlled by the information comparing/processing unit 14 to perform locking or unlocking operation is a reversible motor. In the first embodiment of the wirelessly sensed and controlled locking device 10 further including an operating rod 101 driven by the switch driving/controlling unit 15. The second RF antenna 11, the power storing/supplying unit 12, the information receiving/transmitting unit 13, the information comparing/processing unit 14 and the switch driving/controlling unit 15 are all electrically connected to and installed on a control circuit board 100. In the present invention, the power storing/supplying unit 12 is a capacitor device supplying direct current to the switch driving/controlling unit 15, wherein the power storing/supplying unit 12 is realized by a first capacitor 121 and a second capacitor 122. That is, when the wirelessly sensed and controlled locking device 10 is installed on a door plate 30 and approaching by the mobile electronic device 20, the second RF antenna 11 receiving the electromagnetic waves and the information of the identification code from the first RF antenna 23; the received electromagnetic waves are converted into current and temporarily storing power of the current in storing/supplying unit 12; the information receiving/transmitting unit 13 is powered by the power storing/supplying unit 12 and receiving the information of the identification code from the second RF antenna 11 and transmitting it to the information comparing/processing unit 14; the information comparing/processing unit 14 powered by the power storing/supplying unit 12 to compare and process the identification code which is preset in the information comparing/processing unit 14, and if the same, the switch driving/controlling unit 15 powered by the power storing/supplying unit 12 and controlled by the information comparing/processing unit 14 can drive the operating rod 101 to lock or unlock the locking device 10.

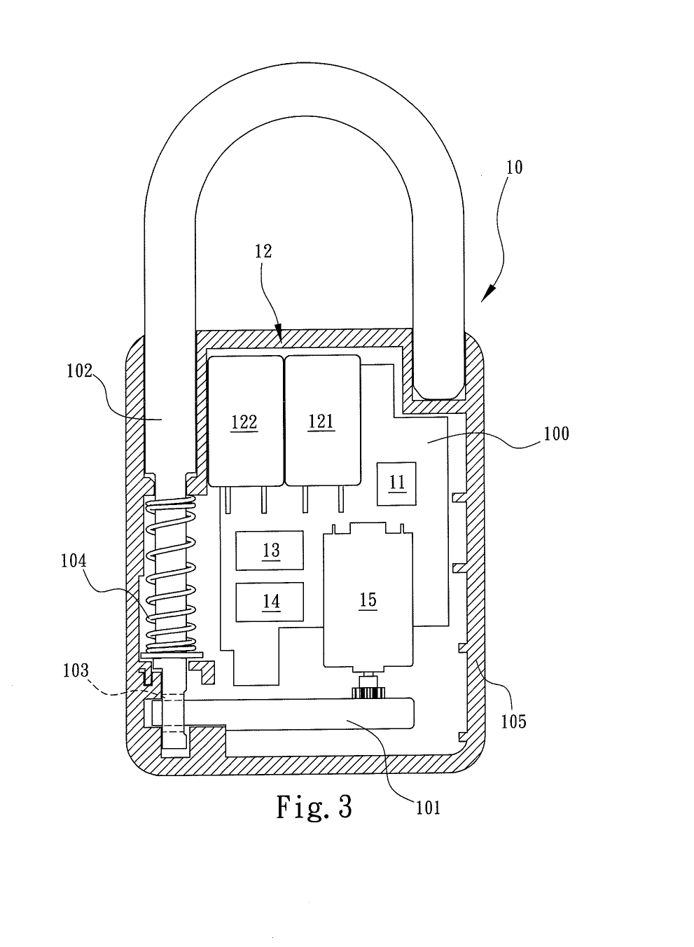

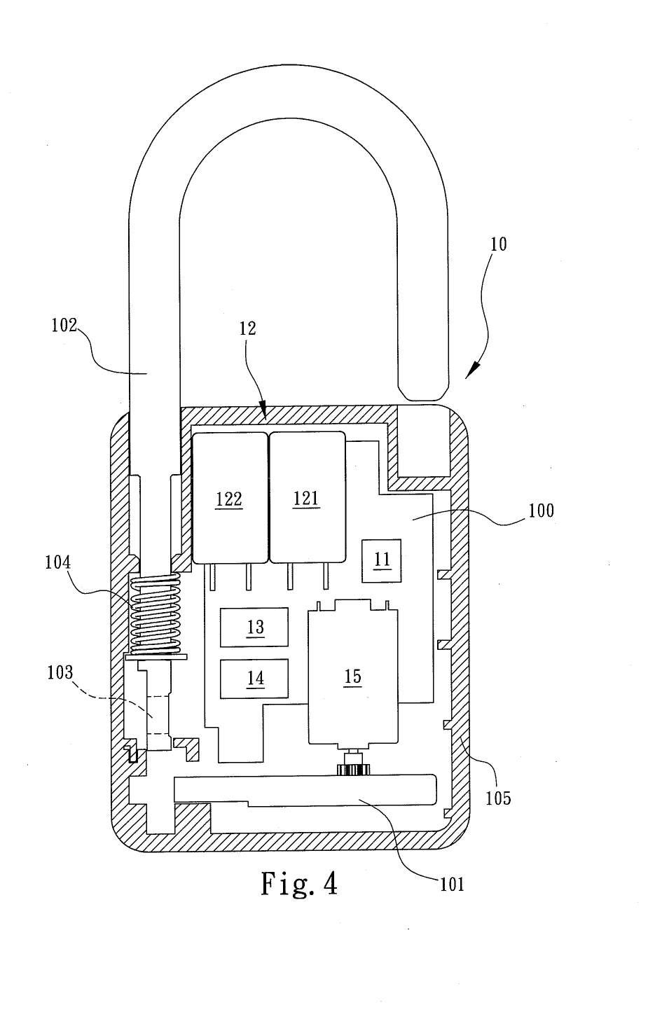

Refer to FIG. 3 and FIG. 4. The switch driving/controlling unit 15 which is powered by the power storing/supplying unit 12 and controlled by the information comparing/processing unit 14 to perform locking or unlocking operation of the locking device 10 is a reversible motor. In the embodiment of the wirelessly sensed and controlled locking device 10 further including an operating rod 101 driven by the switch driving/controlling unit 15, a locking ring 102 including a hole 103 which is inserted by the operating rod 101, a lock casing 105 locked by the locking ring 102 to form a closed state and a spring 104 maintaining the closed state of the locking ring 102 and the lock casing 105 in a normal state. The second RF antenna 11, the power storing/supplying unit 12, the information receiving/transmitting unit 13, the information comparing/processing unit 14 and the switch driving/controlling unit 15 are all electrically connected to and installed on a control circuit board 100 and the power storing/supplying unit 12 is a capacitor device supplying direct current to the switch driving/controlling unit 15 (the power storing/supplying unit 12 is realized by a first capacitor 121 and a second capacitor 122 in the present invention). In the present invention, as show in FIG. 3 and FIG. 4, once the mobile electronic device 20 is made to be close to the wirelessly sensed and controlled locking device 10, the second RF antenna 11 receives the electromagnetic waves and identification code from the first RF antenna 23; the received electromagnetic waves are converted into current and the power of the current is temporarily stored in the first capacitor 121 and the second capacitor 122; the information receiving/transmitting unit 13 is powered by the first capacitor 121 and the second capacitor 122 to receive the information of the identification code from the second RF antenna 11 and transmit it to the information comparing/processing unit 14; the information comparing/processing unit 14 is powered by the first capacitor 121 and the second capacitor 122 to compare the identification code. If the identification code is the same as the identification code preset in the information comparing/processing unit 14, then the switch driving/controlling unit 15 is controlled by the information comparing/processing unit 14 and powered by the forward direct current supplied by the first capacitor 121 to drive the operating rod 101 to move rightward to separate from the hole 103 such that the user can pulls the locking rod 102 to separate one end thereof from the lock casing 105 and rotates the locking rod 102 to form an unlocking state as shown in FIG. 4. Conversely, when user releases the locking rod 102 to let the separate end of the locking rod 102 to join with the lock casing 105 and takes the mobile electronic device 20 close to the locking device 10, the switch driving/controlling unit 15 is controlled by the information comparing/processing unit 14 and powered by the reverse direct current supplied by the second capacitor 122 to drive the operating rod 101 to move leftward to insert into the hole 103. After the takes the mobile electronic device 20 away from the locking device 10, the user cannot separate the locking rod 102 from the lock casing 105 any more to achieve the locking state of the locking device 10 as shown in FIG. 3.

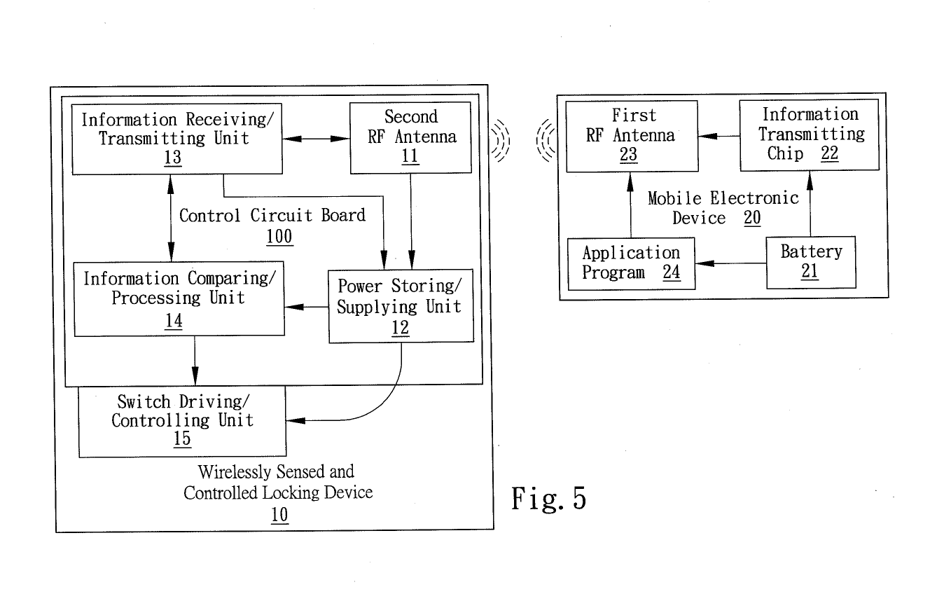

Refer to FIG. 5, the second embodiment is different from the first embodiment in that the mobile electronic device 20 further includes an application program 24 which is powered by the battery 21 and through which the user can setup a password. Once the the mobile electronic device 20 is close to the wirelessly sensed and controlled locking device 10, the second RF antenna 11 receives the electromagnetic waves and the information of the identification code and the password from the first RF antenna 23, the received electromagnetic waves are converted into current and the power of the current is temporarily stored in the power storing/supplying unit 12; the information receiving/transmitting unit 13 is powered by the power storing/supplying unit 12 to receive the information of the identification code and the password from the second RF antenna 11 and transmit it to the information comparing/processing unit 14; the information comparing/processing unit 14 is powered by the power storing/supplying unit 12 to compare the identification code and the password, if the identification code and the password are identical to the identification code and the password that are preset in the information comparing/processing unit 14, the switch driving/controlling unit 15 powered by the power storing/supplying unit 12 and controlled by the information comparing/processing unit 14 can drive the operating rod 101 to lock or unlock the locking device 10.

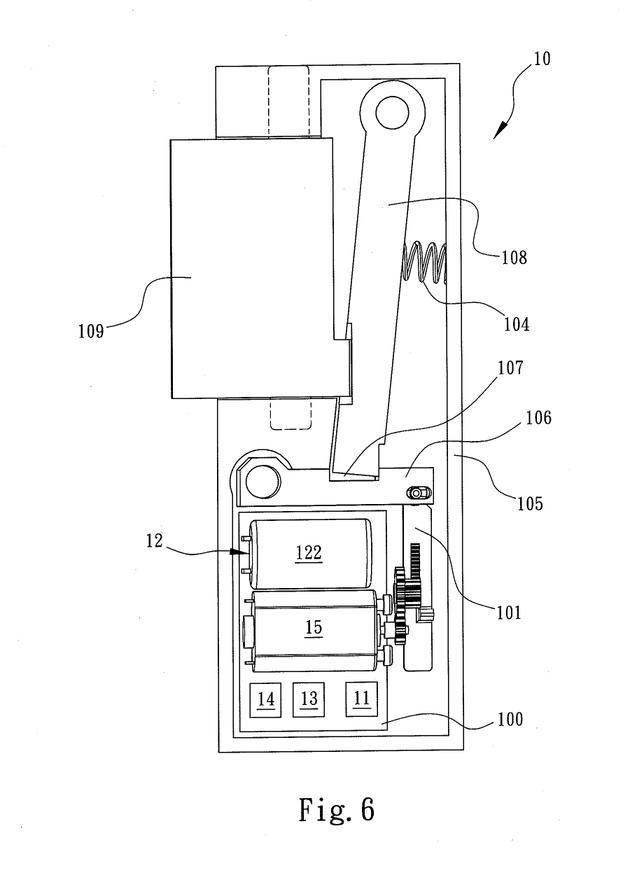

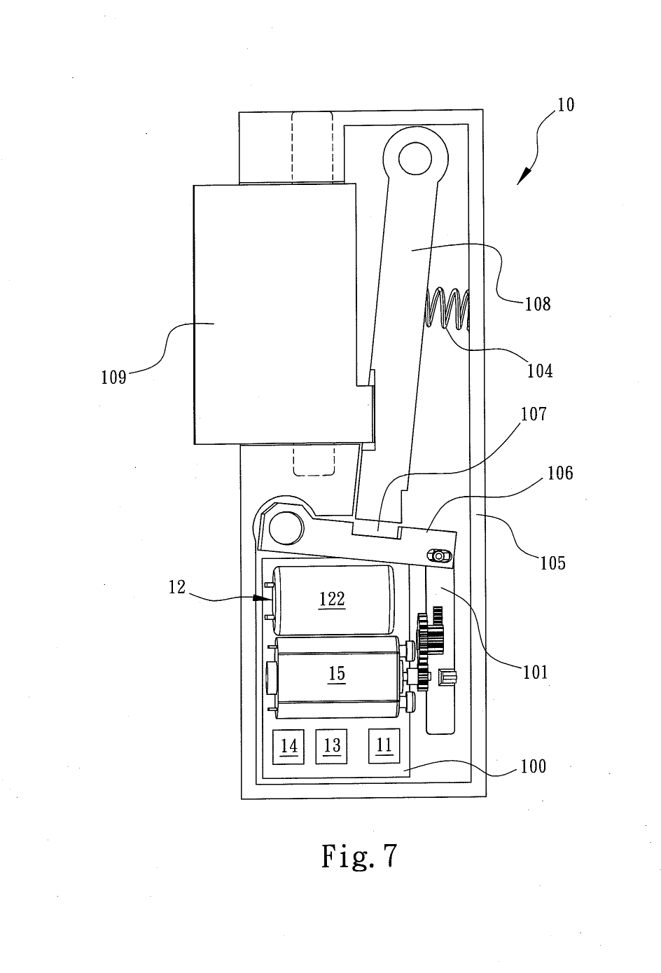

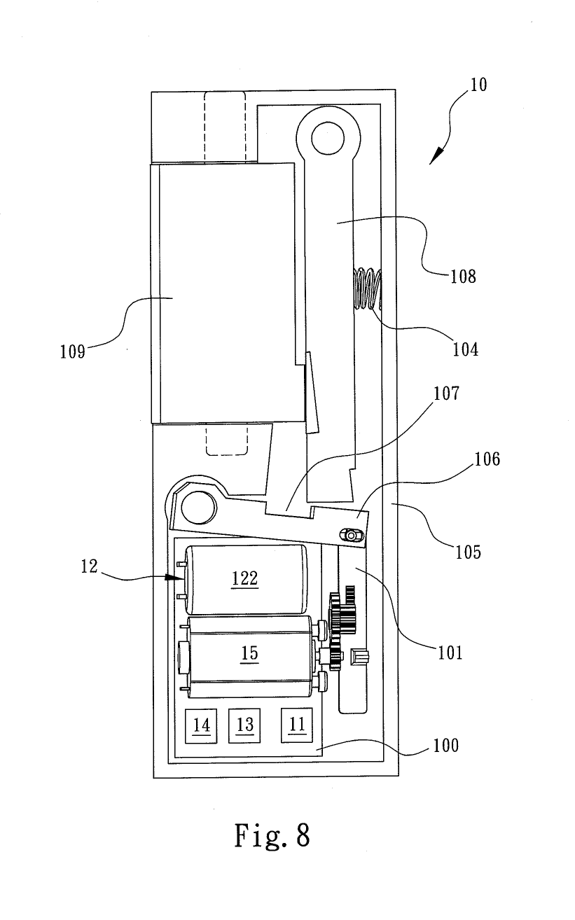

Refer to FIGS. 6-8. The switch driving/controlling unit 15 powered by the power storing/supplying unit 12 and controlled by the information comparing/processing unit 14 to lock or unlock the locking device 10 is a reversible motor. In this embodiment, the wirelessly sensed and controlled locking device 10 further comprises an operating rod 101 driven by the switch driving/controlling unit 15, a first swing lever 106 including a notch 107 latched by a second swing lever 108, a rotatable locking memeber 109 for stopping and positioning the second swing lever 108, and a lock casing 105 which the rotatable locking memeber 109 rotates pivotally and a spring 104 enabling the second swing lever 108 to resist the rotation of the rotatable locking memeber 109 in a normal state. The rotatable locking memeber 109 partially protrudes from the lock casing 105. The operating rod 101 actuates the first swing lever 106 to swing. The second RF antenna 11, the power storing/supplying unit 12, the information receiving/transmitting unit 13, the information comparing/processing unit 14 and the switch driving/controlling unit 15 are all electrically connected to and installed on a control circuit board 100. The power storing/supplying unit 12 is a capacitor device supplying direct current to the switch driving/controlling unit 15. Accoirding to the embodiment shown in FIGS. 6-8, once the mobile electronic device 20 is close to the wirelessly sensed and controlled locking device 10, the second RF antenna 11 receives the electromagnetic waves and the information of the identification code from the first RF antenna 23 and the received electromagnetic waves are converted into current and the power of the current is temporarily stored in the power storing/supplying unit 12; the information receiving/transmitting unit 13 powered by the power storing/supplying unit 12 and receiving the information of the identification code and the password from the second RF antenna 11 and transmitting it to the information comparing/processing unit 14; the information comparing/processing unit 14 powered by the power storing/supplying unit 12 to compare the identification code and the password, if the identification code and the password are identical to the identification code and the password that are preset in the information comparing/processing unit 14, then the switch driving/controlling unit 15 powered by the forward direct current supplied by the power storing/supplying unit 12 and controlled by the information comparing/processing unit 14 is to drive the operating rod 101 to move downward, whereby the second swing lever 108 separates from the notch 107 as shown in FIG. 7, then the user pushes one end of the rotatable locking memeber 109 to rotate pivotally into the lock casing 105 to reach an unlocking state as shown in FIG. 8, which also shows that the second swing lever 108 is pushed rightward to compress the spring 104. When the user releases the rotatable locking memeber 109, the resilience of the spring 104 drives the second swing rod 108 to push the rotatable locking memeber 109 and make one end thereof to partially protrude from the lock casing 105. When the mobile electronic device 20 is close to the locking device 10, the switch driving/controlling unit 15 controlled by the information comparing/processing unit 14 and powered by the reverse direct current supplied by the second capacitor 122 is to drive the operating rod 101 to move upward, whereby the notch 107 is fixedly coupled to the second swing rod 108. When the the mobile electronic device 20 has been taken away, the user cannot push back the rotatable locking memeber 109 any more, and the locking device 10 is in a locking state once again as shown in FIG. 6.

The present invention has been described in detail with the embodiments. However, these embodiments are only to exemplify the present invention but not to limit the scope of the present invention. Any equivalent modification or variation according to the spirit of the present invention is to be also included within the scope of the present invention.

What is claimed is:

1. A wirelessly sensed and controlled locking device, which is wirelessly identified, sensed and controlled by a mobile electronic device to be locked or unlocked, and wherein the mobile electronic device includes a battery, an information transmission chip powered by the battery, and a first radio frequency antenna transmitting information of the information transmission chip through electromagnetic waves; the wirelessly sensed and controlled locking device comprising:
a second radio frequency antenna receiving the information and the electromagnetic waves from the first radio frequency antenna;
an information receiving/transmitting unit controlling the second radio frequency antenna to receive and transmit the information;
a power storing/supplying unit converting the electromagnetic waves received by the second radio frequency antenna into current and temporarily storing power of the current, and temporarily storing power from the information receiving/transmitting unit;
an information comparing/processing unit powered by the power storing/supplying unit to compare and process the information from the information receiving/transmitting unit; and
a switch driving/controlling unit powered by the power storing/supplying unit and controlled by the information comparing/processing unit to perform locking or unlocking operation.

2. The wirelessly sensed and controlled locking device of claim 1, wherein the second radio frequency antenna, the power storing/supplying unit, the information receiving/transmitting unit, the information comparing/processing unit and the switch driving/controlling unit are electrically connected to and installed on a control circuit board , and wherein the first radio frequency antenna and the second radio frequency antenna are wirelessly transmitted via a Near Field Communication standard.

3. The wirelessly sensed and controlled locking device of claim 1 further comprising an operating rod driven by the switch driving/controlling unit.

4. The wirelessly sensed and controlled locking device of claim 2 further comprising an operating rod driven by the switch driving/controlling unit.

5. The wirelessly sensed and controlled locking device of claim 4 further comprising a locking ring including a hole which is inserted by the operating rod, and a lock casing locked by the locking ring to form a closed state.

6. The wirelessly sensed and controlled locking device of claim 4 further comprising a first swing lever including a notch latched by a second swing lever, a rotatable locking member for stopping and positioning the second swing lever, and a lock casing where the rotatable locking member rotates pivotally; wherein the rotatable locking memeber partially protrudes from the lock casing, and wherein the first swing lever is driven by the operating rod to swing.

7. The wirelessly sensed and controlled locking device of claim 1, wherein the mobile electronic device further includes an application program which is powered by the battery and transmits the information through the electromagnetic waves from the first radio frequency antenna to the second radio frequency antenna.

8. The wirelessly sensed and controlled locking device of claim 2, wherein the mobile electronic device further includes an application program which is powered by the battery and transmits the information through the electromagnetic waves from the first radio frequency antenna to the second radio frequency antenna.

9. The wirelessly sensed and controlled locking device of claim 3, wherein the mobile electronic device further includes an application program which is powered by the battery and transmits the information through the electromagnetic waves from the first radio frequency antenna to the second radio frequency antenna.

10. The wirelessly sensed and controlled locking device of claim 4, wherein the mobile electronic device further includes an application program which is powered by the battery and transmits the information through the electromagnetic waves from the first radio frequency antenna to the second radio frequency antenna.

11. The wirelessly sensed and controlled locking device of claim 1, wherein the switch driving/controlling unit is a reversible motor.

12. The wirelessly sensed and controlled locking device of claim 2, wherein the switch driving/controlling unit is a reversible motor.

13. The wirelessly sensed and controlled locking device of claim 3, wherein the switch driving/controlling unit is a reversible motor.

14. The wirelessly sensed and controlled locking device of claim 11, wherein the power storing/supplying unit is a capacitor.

15. The wirelessly sensed and controlled locking device of claim 12, wherein the power storing/supplying unit is a capacitor.

16. The wirelessly sensed and controlled locking device of claim 13, wherein the power storing/supplying unit is a capacitor.
